(19) United States
(12) Patent Application Publication
(10) Pub. No.: US 2024/0188133 A1
(43) Pub. Date: Jun. 6, 2024

(54) Methods for Wi-Fi Infrastructure Network and P2P Connection/Co-existence Technology Management

(71) Applicant: Apple Inc, Cupertino, CA (US)

(72) Inventors: Qi Wang, Sunnyvale, CA (US); Charles F Dominguez, Redwood City, CA (US); Jarkko L Kneckt, Los Gatos, CA (US); Yong Liu, Campbell, CA (US); Oren Shani, Saratoga, CA (US); Debashis Dash, San Jose, CA (US); Mohamed Abouelseoud, Burlingame, CA (US); Yoel Boger, Shoham (IL); Su Khiong Yong, Cupertino, CA (US); Zhou Lan, San Jose, CA (US); Anuj Batra, Redwood City, CA (US); Ahmad Reza Hedayat, Carlsbad, CA (US); Jinjing Jiang, San Jose, CA (US)

(21) Appl. No.: 18/458,935

(22) Filed: Aug. 30, 2023

Related U.S. Application Data
(60) Provisional application No. 63/490,484, filed on Mar. 15, 2023.
(60) Provisional application No. 63/429,761, filed on Dec. 2, 2022.

(51) Int. Cl. H04W 74/08

(52) U.S. Cl. CPC H04W 74/0816

(57) ABSTRACT

Systems, methods, and mechanisms for a Probe-Before-Talk (PBT) to manage the operation of Wi-Fi multiple interfaces and/or Wi-Fi co-existence with other technologies. Further, embodiments described herein relate to systems, methods, and mechanisms for PBT setup, a PBT session, and PBT termination. The systems, methods, and mechanisms described herein may support either a wireless station or an access point as an initiator of a transmit opportunity.

### PRIORITY DATA

This application claims benefit of priority to U.S. Provisional Application Ser. No. 63/490,484, titled “Methods for Wi-Fi Infrastructure Network and P2P Connection/Co-existence Technology Management”, filed Mar. 15, 2023, and U.S. Provisional Application Ser. No. 63/429,761, titled “Methods for Wi-Fi Infrastructure Network and P2P Connection/Co-existence Technology Management”, filed Dec. 2, 2022, each of which is hereby incorporated by reference in its entirety as though fully and completely set forth herein.

### FIELD

The present application relates to wireless communications, including techniques for a Probe-Before-Talk (PBT) to manage the operation of Wi-Fi multiple interfaces and/or Wi-Fi co-existence with other technologies, e.g., for concurrent single link and/or a single wireless station.

### DESCRIPTION OF THE RELATED ART

In current implementations, a wireless local area network (WLAN) device (e.g., a wireless station) often needs to manage multiple Wi-Fi interfaces. For example, the WLAN device may need to manage an infrastructure Wi-Fi connection with an access point and a Wi-Fi peer-to-peer (P2P) connection with another WLAN device. Both of these connections may be on the same link. As another example, the WLAN device may need to manage co-existence between radio access technologies such Wi-Fi and Bluetooth. In addition, radio resources within the WLAN device are time shared by the infrastructure Wi-Fi connection, the P2P connection, and any co-existing radio access technologies. Given that the WLAN device dynamically time shares the radio resources between the various competing elements, communications may collide leading to a reduction in transmission rate which may not be suitable based on the reasons for failed transmissions and, as such, the transmission rate reduction may be undesirable. Therefore, improvements are desired.

### SUMMARY

Embodiments described herein relate to systems, methods, and mechanisms for a Probe-Before-Talk (PBT) to manage the operation of Wi-Fi multiple interfaces and/or Wi-Fi co-existence with other technologies. Note that in some embodiments, when the PBT is applied to an infrastructure scenario, a transmit opportunity initiation may be an access point and a transmit opportunity responder may be a wireless station. Additionally, not that in some embodiments, when the PBT is applied to a peer-to-peer scenario, a transmit opportunity initiation may be an access point and/or wireless station and a transmit opportunity responder may be a wireless station and/or access point. In other words, the systems, methods, and mechanisms described herein may support either a wireless station or an access point as an initiator of a transmit opportunity. Further, embodiments described herein relate to systems, methods, and mechanisms for PBT setup, a PBT session, and PBT termination.

For example, in some embodiments, a wireless station may be configured to request setup of a PBT session and receive a request-to-send (RTS) frame from a transmit opportunity initiator. Further, the wireless station may be configured to transmit one of a clear-to-send (CTS) frame or a modified CTS frame to the transmit opportunity initiator and receive data from the transmit opportunity initiator. A duration field of the CTS frame may be interpreted as a PBT transmit opportunity duration. In addition, a modified CTS frame may include one or more of a frame control field, a duration field, a receiver address (RA) field, a future unavailability profile field, and/or an FCS field. The future unavailability profile field may include one or more of a control field, a future unavailability start time (offset) field, and/or a minimum future unavailability duration field. In some examples, the control field may indicate whether a future unavailable profile is included and/or whether a transmitter of a modified CTS frame will be in a power save mode/state at the end of a PBT transmit opportunity duration and onward. The RTS frame may be a single user (SU) RTS (SU-RTS) frame, a multi-user (MU) RTS (MU-RTS) frame, and/or a modified RTS that serves the same/similar function as a SU-RTS frame and/or an MU RTS frame.

As another example, in some embodiments, a wireless station may be configured to receiving a request to setup a PBT session and transmit a request-to-send (RTS) frame to a transmit opportunity responder. Further, the wireless station may be configured to receive one of a clear-to-send (CTS) frame or a modified CTS frame from the transmit opportunity responder and transmit data to the transmit opportunity responder. A duration field of the CTS frame may be interpreted as a PBT transmit opportunity duration. In addition, a modified CTS frame may include one or more of a frame control field, a duration field, an RA field, a future unavailability profile field, and/or an FCS field. The future unavailability profile field may include one or more of a control field, a future unavailability start time (offset) field, and/or a minimum future unavailability duration field. In some examples, the control field may indicate whether a future unavailable profile is included and/or whether a transmitter of a modified CTS frame will be in a power save mode/state at the end of a PBT transmit opportunity duration and onward.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example of a wireless communication system, according to some embodiments.

FIG. 2A illustrates an example of wireless devices communicating, according to some embodiments.

FIG. 2B illustrates an example simplified block diagram of a wireless device, according to some embodiments.

FIG. 2C illustrates an example WLAN communication system, according to some embodiments.

FIG. 3A illustrates an example simplified block diagram of a WLAN Access Point (AP), according to some embodiments.

FIG. 3B illustrates an example simplified block diagram of a wireless station (UE), according to some embodiments.

FIG. 3C illustrates an example simplified block diagram of a wireless node, according to some embodiments.

FIG. 4A illustrates examples of connections for a WLAN device.

FIG. 4B illustrates examples of time sharing between connections of a WLAN device.

FIG. 5 illustrates an example of signaling for a PBT procedure, according to some embodiments.

FIGS. 6A and 6B illustrate examples of signaling for PBT session setup, according to some embodiments.

FIG. 7 illustrates an example of a container for information associated with PBT setup, according to some embodiments.

FIGS. 8A and 8B illustrate examples of transmit opportunities using PBT, according to some embodiments.

FIG. 9 illustrates an example of timing of RTS, CTS, and modified CTS frames, according to some embodiments.

FIGS. 10 and 11A illustrate examples of modified CTS frame formats, according to some embodiments.

FIG. 11B illustrates an example of a future unavailability profile field of a modified CTS frame, according to some embodiments.

FIG. 12A illustrates another example of a modified CTS frame format, according to some embodiments.

FIG. 12B illustrates another example of a future unavailability profile field of a modified CTS frame, according to some embodiments

FIG. 13A illustrates timing of signaling when a PBT transmit opportunity duration is less than an RTS duration, according to some embodiments.

FIG. 13B illustrates timing of signaling when a PBT transmit opportunity duration is equal to an RTS duration, according to some embodiments.

FIG. 14 illustrates an example of signaling when a transmit opportunity initiator does not receive a CTS (or modified CTS) frame, according to some embodiments.

FIG. 15A illustrates an example of a modified CTS frame expanded to support multiple links, according to some embodiments.

FIG. 15B illustrates an example of a future unavailability profile field of a modified CTS frame expanded to support multiple links, according to some embodiments.

FIG. 16 illustrates an example of signaling when using PBT for multiple links, according to some embodiments.

FIG. 17 illustrates an example of signaling of an unsolicited modified CTS frame, according to some embodiments.

FIG. 18 illustrates an example of an eBSRP frame, according to some embodiments.

FIG. 19 illustrates an example signaling for multi-user PBT, according to some embodiments.

FIGS. 20 and 21 illustrate block diagrams of examples of methods for a PBT procedure, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present application. Definitions of the most prominently used acronyms that may appear throughout the present application are provided below:
UE: User Equipment
AP: Access Point
TX: Transmission/Transmit
RX: Reception/Receive
UWB: Ultra-wideband
BT/BLE: BLUETOOTH™/BLUETOOTH™ Low Energy
LAN: Local Area Network
WLAN: Wireless LAN
RAT: Radio Access Technology

### Terminology

The following is a glossary of terms used in this disclosure:
Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.
Positional Tag (or tracking device)—any of various types of computer systems devices which are mobile or portable and which performs wireless communications, such as communication with a neighboring or companion device to share, determine, and/or update a location of the positional tag. Wireless communication can be via various protocols, including, but not limited to, Bluetooth, Bluetooth Low Energy (BLE), Wi-Fi, ultra-wide band (UWB), and/or one or more proprietary communication protocols.
Mobile Device (or Mobile Station)—any of various types of computer systems devices which are mobile or portable and which performs wireless communications using WLAN communication. Examples of mobile devices include mobile telephones or smart phones (e.g., iPhone™, Android™-based phones), and tablet computers such as iPad™, Samsung Galaxy™, etc. Various other types of devices would fall into this category if they include Wi-Fi or both cellular and Wi-Fi communication capabilities, such as laptop computers (e.g., MacBook™), portable gaming devices (e.g., Nintendo DS™, PlayStation Portable™, Gameboy Advance™, iPhone™), portable Internet devices, and other handheld devices, as well as wearable devices such as smart watches, smart glasses, headphones, pendants, earpieces, etc. In general, the term “mobile device” can be broadly defined to encompass any electronic, computing, and/or telecommunications device (or combination of devices) which is easily transported by a user and capable of wireless communication using WLAN or Wi-Fi.
Wireless Device (or Wireless Station)—any of various types of computer systems devices which performs wireless communications using WLAN communications. As used herein, the term “wireless device” may refer to a mobile device, as defined above, or to a stationary device, such as a stationary wireless client or a wireless base station. For example, a wireless device may be any type of wireless station of an 802.11 system, such as an access point (AP) or a client station (STA or UE). Further examples include televisions, media players (e.g., AppleTV™, Roku™, Amazon FireTV™, Google Chromecast™, etc.), refrigerators, laundry machines, thermostats, and so forth.
WLAN—The term “WLAN” has the full breadth of its ordinary meaning, and at least includes a wireless communication network or RAT that is serviced by WLAN access points and which provides connectivity through these access points to the Internet. Most modern WLANs are based on IEEE 802.11 standards and are marketed under the name “Wi-Fi”. A WLAN network is different from a cellular network.
Processing Element—refers to various implementations of digital circuitry that perform a function in a computer system. Additionally, processing element may refer to various implementations of analog or mixed-signal (combination of analog and digital) circuitry that perform a function (or functions) in a computer or computer system. Processing elements include, for example, circuits such as an integrated circuit (IC), ASIC (Application Specific Integrated Circuit), portions or circuits of individual processor cores, entire processor cores, individual processors, programmable hardware devices such as a field programmable gate array (FPGA), and/or larger portions of systems that include multiple processors.
Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, e.g., are not performed “manually”, where the user specifies cach action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.
Concurrent—refers to parallel execution or performance, where tasks, processes, signaling, messaging, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.
Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

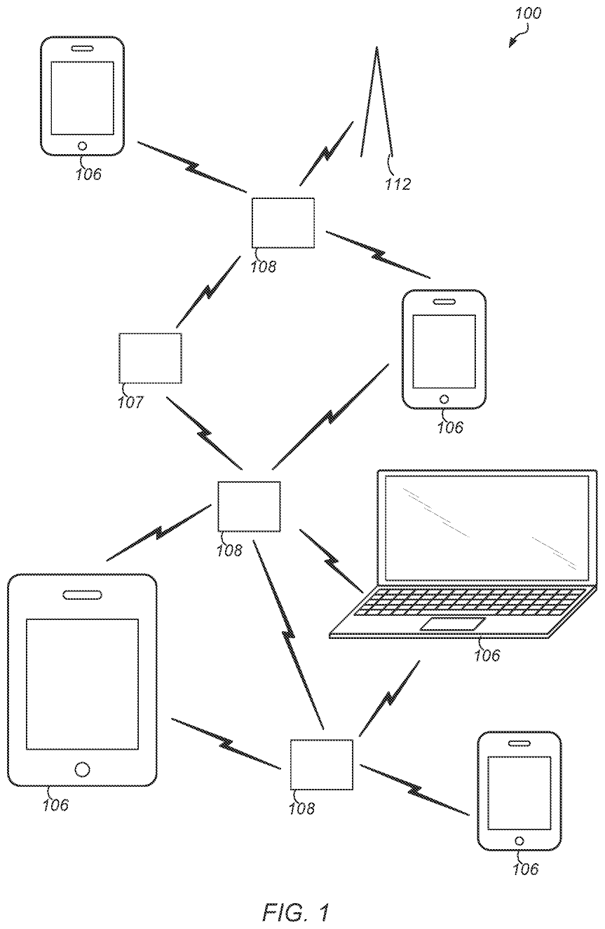

### FIG. 1—Wireless Communication System

FIG. 1 illustrates an example wireless communication system, according to some embodiments. It is noted that the system of FIG. 1 is merely one example of a possible system, and embodiments of this disclosure may be implemented in any of various systems, as desired. As shown, the exemplary system 100 includes a plurality of wireless client stations or devices, or user equipment (UEs), 106 that are configured to communicate wirelessly with various components within the system 100, such as an Access Point (AP) 112, other client stations 106, wireless nodes 107, and/or positional tag devices 108. Some implementations can include one or more base stations in addition to, or in place of, AP 112. The AP 112 may be a Wi-Fi access point and may include one or more other radios/access technologies (e.g., Bluetooth (BT), ultra-wide band (UWB), etc.) for wirelessly communicating with the various components of system 100. The AP 112 may communicate via wired and/or wireless communication channels with one or more other electronic devices (not shown) and/or another network, such as the Internet. The AP 112 may be configured to operate according to any of various communications standards, such as the various IEEE 802.11 standards as well as one or more proprietary communication standards, e.g., based on wideband, ultra-wideband, and/or additional short range/low power wireless communication technologies. In some embodiments, at least one client station 106 may be configured to communicate directly with one or more neighboring devices (e.g., other client stations 106, wireless nodes 107, and/or positional tag devices 108), without use of the access point 112 (e.g., peer-to-peer (P2P) or device-to-device (D2D)). As shown, wireless node 107 may be implemented as any of a variety of devices, such as wearable devices, gaming devices, and so forth. In some embodiments, wireless node 107 may be various Internet of Things (IOT) devices, such as smart appliances (e.g., refrigerator, stove, oven, dish washer, clothes washer, clothes dryer, and so forth), smart thermostats, and/or other home automation devices (e.g., such as smart electrical outlets, smart lighting fixtures, and so forth).

As shown, a positional tag device 108 may communicate with one or more other components within system 100. In some embodiments, positional tag device 108 may be associated with a companion device (e.g., a client station 106) and additionally be capable of communicating with one or more additional devices (e.g., other client stations 106, wireless nodes 107, AP 112). In some embodiments, communication with the companion device may be via one or more access technologies/protocols, such as BLUETOOTH™ (and/or BLUETOOTH™ (BT) Low Energy (BLE)), Wi-Fi peer-to-peer (e.g., Wi-Fi Direct, Neighbor Awareness Networking (NAN), and so forth), millimeter wave (mmWave) (e.g., 60 GHz, such as 802.11 ad/ay), as well as any of various proprietary protocols (e.g., via wideband or ultra-wideband (UWB) and/or low and/or ultra-low power (LP/ULP) wireless communication). In some embodiments, communication with additional devices may be via BT/BLE as well as one or more other short-range peer-to-peer wireless communication techniques (e.g., various near-field communication (NFC) techniques, RFID, NAN, Wi-Fi Direct, UWB, LT/ULP, and so forth). In some embodiments, positional tag device 108 may be capable of updating a server with a current location (e.g., determined by tag device 108 and/or provided to tag device 108 from another device) via the one or more additional devices as well as via the companion device.

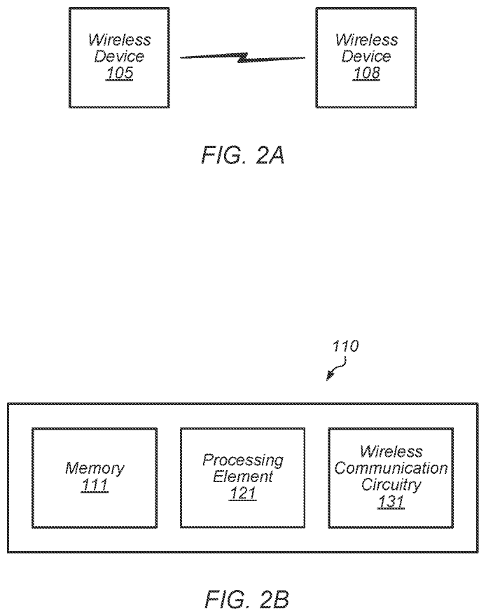

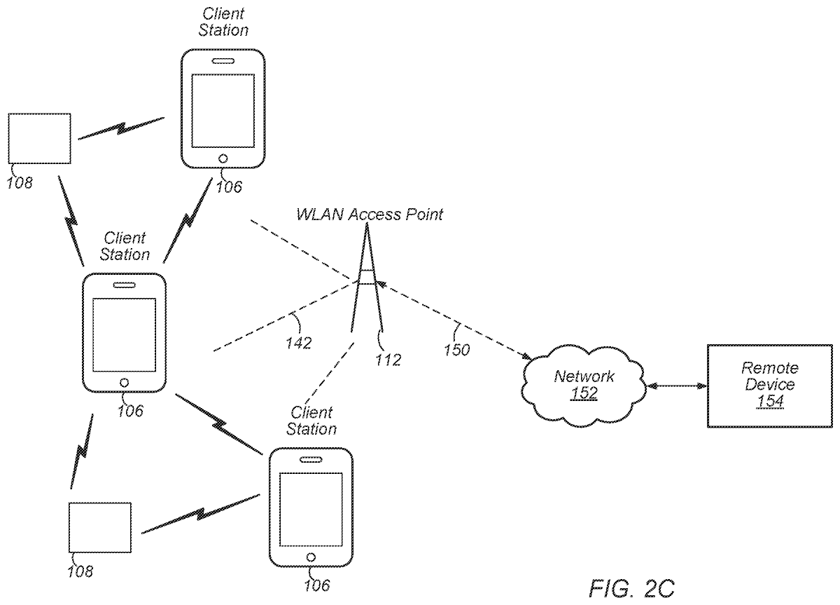

### FIGS. 2A-2B—Wireless Communication System

FIG. 2A illustrates an exemplary (and simplified) wireless communication system in which aspects of this disclosure may be implemented. It is noted that the system of FIG. 2A is merely one example of a possible system, and embodiments of this disclosure may be implemented in any of various systems, as desired.

As shown, the exemplary wireless communication system includes a (“first”) wireless device 105 in communication with another (“second”) wireless device 108. The first wireless device 105 and the second wireless device 108 may communicate wirelessly using any of a variety of wireless communication techniques.

As one possibility, the first wireless device 105 and the second wireless device 108 may perform communication using wireless local area networking (WLAN) communication technology (e.g., IEEE 802.11/Wi-Fi based communication) and/or techniques based on WLAN wireless communication. One or both of the wireless device 105 and the wireless device 108 may also (or alternatively) be capable of communicating via one or more additional wireless communication protocols, such as any of BLUETOOTH™ (BT), BLUETOOTH™ Low Energy (BLE), near field communication (NFC), RFID, UWB, LP/ULP, GSM, UMTS (WCDMA, TDSCDMA), LTE, LTE-Advanced (LTE-A), NR, 3GPP2 CDMA2000 (e.g., 1×RTT, 1×EV-DO, HRPD, eHRPD), Wi-MAX, GPS, etc.

The wireless devices 105 and 108 may be any of a variety of types of wireless device. As one possibility, wireless device 105 may be a substantially portable wireless user equipment (UE) device, such as a smart phone, hand-held device, a laptop computer, a wearable device (such as a smart watch), a tablet, a motor vehicle, or virtually any type of wireless device. As another possibility, wireless device 105 may be a substantially stationary device, such as a payment kiosk/payment device, point of sale (POS) terminal, set top box, media player (e.g., an audio or audiovisual device), gaming console, desktop computer, appliance, door, access point, base station, or any of a variety of other types of device. The wireless device 108 may be a positional tag device, e.g., in a stand-alone form factor, associated with, attached to, and/or otherwise integrated into another computing device, and/or associated with, attached to, and/or integrated into a personal article or device (e.g., a wallet, a backpack, luggage, a briefcase, a purse, a key ring/chain, personal identification, and so forth) and/or a commercial article (e.g., a shipping container, shipping/storage pallet, an item of inventory, a vehicle, and so forth).

Each of the wireless devices 105 and 108 may include wireless communication circuitry configured to facilitate the performance of wireless communication, which may include various digital and/or analog radio frequency (RF) components, one or more processors configured to execute program instructions stored in memory, one or more programmable hardware elements such as a field-programmable gate array (FPGA), a programmable logic device (PLD), an application specific IC (ASIC), and/or any of various other components. The wireless device 105 and/or the wireless device 108 may perform any of the method embodiments or operations described herein, or any portion of any of the method embodiments or operations described herein, using any or all of such components.

Each of the wireless devices 105 and 108 may include one or more antennas and corresponding radio frequency front-end circuitry for communicating using one or more wireless communication protocols. In some cases, one or more parts of a receive and/or transmit chain may be shared between multiple wireless communication standards; for example, a device might be configured to communicate using BT/BLE or Wi-Fi using partially or entirely shared wireless communication circuitry (e.g., using a shared radio or one or more shared radio components). The shared communication circuitry may include a single antenna, or may include multiple antennas (e.g., for MIMO) for performing wireless communications. Alternatively, a device may include separate transmit and/or receive chains (e.g., including separate antennas and other radio components) for each wireless communication protocol with which it is configured to communicate. As a further possibility, a device may include one or more radios or radio components that are shared between multiple wireless communication protocols, and one or more radios or radio components that are used exclusively by a single wireless communication protocol. For example, a device might include a shared radio for communicating using one or more of LTE, CDMA2000 1×RTT. GSM, and/or 5G NR, and one or more separate radios for communicating using Wi-Fi and/or BT/BLE. Other configurations are also possible.

As previously noted, aspects of this disclosure may be implemented in conjunction with the wireless communication system of FIG. 2A. For example, a wireless device (e.g., either of wireless devices 105 or 108) may be configured to implement (and/or assist in implementation of) the methods described herein.

FIG. 2B illustrates an exemplary wireless device 110 (e.g., corresponding to wireless devices 105 and/or 108) that may be configured for use in conjunction with various aspects of the present disclosure. The device 110 may be any of a variety of types of device and may be configured to perform any of a variety of types of functionality. The device 110 may be a substantially portable device or may be a substantially stationary device, potentially including any of a variety of types of device. The device 110 may be configured to perform any of the techniques or features illustrated and/or described herein, including with respect to any or all of the Figures.

As shown, the device 110 may include a processing element 121. The processing element may include or be coupled to one or more memory elements. For example, the device 110 may include one or more memory media (e.g., memory 111), which may include any of a variety of types of memory and may serve any of a variety of functions. For example, memory 111 could be RAM serving as a system memory for processing element 121. Additionally or alternatively, memory 111 could be ROM serving as a configuration memory for device 110. Other types and functions of memory are also possible.

Additionally, the device 110 may include wireless communication circuitry 131. The wireless communication circuitry may include any of a variety of communication elements (e.g., antenna for wireless communication, analog and/or digital communication circuitry/controllers, etc.) and may enable the device to wirelessly communicate using one or more wireless communication protocols.

Note that in some cases, the wireless communication circuitry 131 may include its own processing element(s) (e.g., a baseband processor), e.g., in addition to the processing element 121. For example, the processing element 121 may be an ‘application processor’ whose primary function may be to support application layer operations in the device 110, while the wireless communication circuitry 131 may be a ‘baseband processor’ whose primary function may be to support baseband layer operations (e.g., to facilitate wireless communication between the device 110 and other devices) in the device 110. In other words, in some cases the device 110 may include multiple processing elements (e.g., may be a multi-processor device). Other configurations (e.g., instead of or in addition to an application processor/baseband processor configuration) utilizing a multi-processor architecture are also possible.

The device 110 may additionally include any of a variety of other components (not shown) for implementing device functionality, depending on the intended functionality of the device 110, which may include further processing and/or memory elements (e.g., audio processing circuitry), one or more power supply elements (which may rely on battery power and/or an external power source) user interface elements (e.g., display, speaker, microphone, camera, keyboard, mouse, touchscreen, etc.), and/or any of various other components.

The components of the device 110, such as processing element 121, memory 111, and wireless communication circuitry 131, may be operatively (or communicatively) coupled via one or more interconnection interfaces, which may include any of a variety of types of interfaces, possibly including a combination of multiple types of interfaces. As one example, a USB high-speed inter-chip (HSIC) interface may be provided for inter-chip communications between processing elements. Alternatively (or in addition), a universal asynchronous receiver transmitter (UART) interface, a serial peripheral interface (SPI), inter-integrated circuit (I2C), system management bus (SMBus), and/or any of a variety of other communication interfaces may be used for communications between various device components. Other types of interfaces (e.g., intra-chip interfaces for communication within processing element 121, peripheral interfaces for communication with peripheral components within or external to device 110, etc.) may also be provided as part of device 110.

### FIG. 2C—WLAN System

FIG. 2C illustrates an example WLAN system according to some embodiments. As shown, the exemplary WLAN system includes a plurality of wireless client stations or devices, or user equipment (UEs), 106 that are configured to communicate over a wireless communication channel 142 with an Access Point (AP) 112. In some embodiments, the AP 112 may be a Wi-Fi access point. The AP 112 may communicate via wired and/or wireless communication channel(s) 150 with one or more other electronic devices (not shown) and/or another network 152, such as the Internet. Additional electronic devices, such as the remote device 154, may communicate with components of the WLAN system via the network 152. For example, the remote device 154 may be another wireless client station. The WLAN system may be configured to operate according to any of various communications standards, such as the various IEEE 802.11 standards. In some embodiments, at least one wireless device 106 is configured to communicate directly with one or more neighboring mobile devices, such as positional tag devices 108, without use of the access point 112.

Further, in some embodiments, as further described below, a wireless device 106 (which may be an exemplary implementation of device 110) may be configured to perform (and/or assist in performance of) the methods described herein.

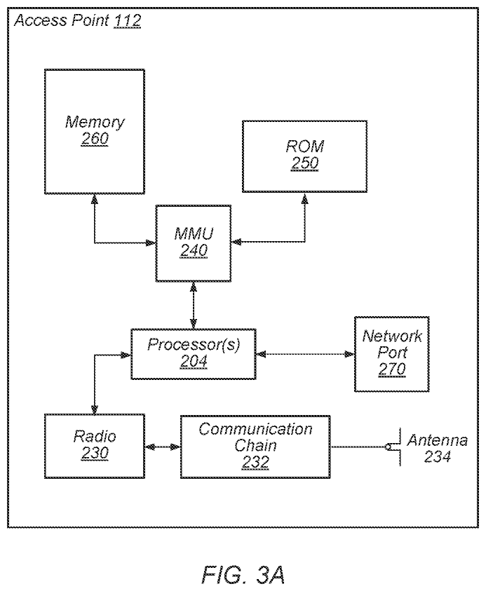

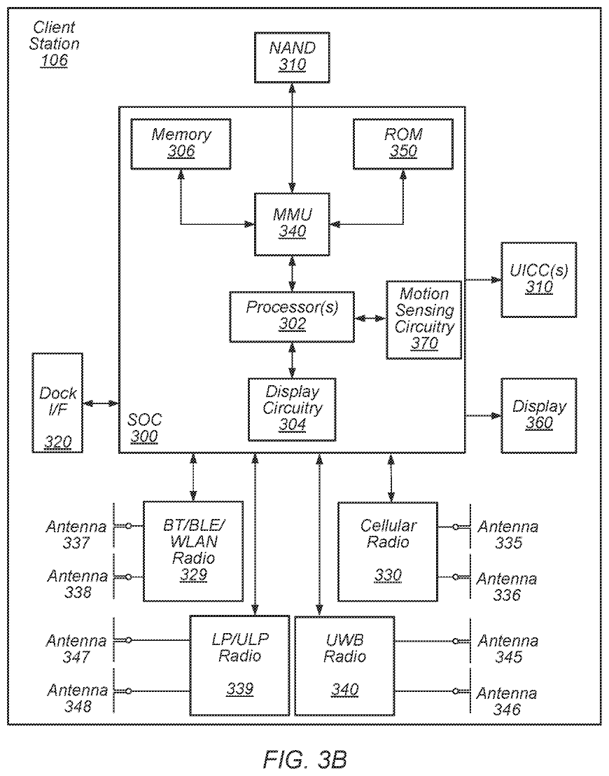

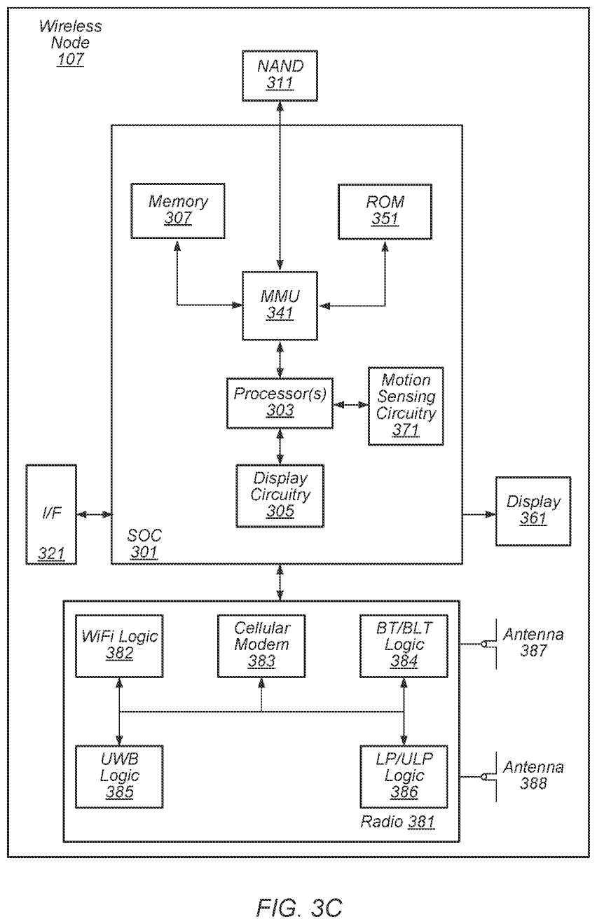

### FIG. 3A—Access Point Block Diagram

FIG. 3A illustrates an exemplary block diagram of an access point (AP) 112, which may be one possible exemplary implementation of the device 110 illustrated in FIG. 2B. It is noted that the block diagram of the AP of FIG. 3A is only one example of a possible system. As shown, the AP 112 may include processor(s) 204, which may execute program instructions for the AP 112. The processor(s) 204 may also be coupled (directly or indirectly) to memory management unit (MMU) 240, which may be configured to receive addresses from the processor(s) 204 and to translate those addresses into locations in memory (e.g., memory 260 and read only memory (ROM) 250) or to other circuits or devices.

The AP 112 may include at least one network port 270. The network port 270 may be configured to couple to a wired network and provide a plurality of devices, such as mobile devices 106, access to the Internet. For example, the network port 270 (or an additional network port) may be configured to couple to a local network, such as a home network or an enterprise network. For example, port 270 may be an Ethernet port. The local network may provide connectivity to one or more additional networks, such as the Internet.

The AP 112 may include at least one antenna 234 and wireless communication circuitry 230, which may be configured to operate as a wireless transceiver and may be further configured to communicate with mobile device 106 (as well as positional tag device 108). The antenna 234 communicates with the wireless communication circuitry 230 via communication chain 232. Communication chain 232 may include one or more receive chains and/or one or more transmit chains. The wireless communication circuitry 230 may be configured to communicate via Wi-Fi or WLAN, e.g., 802.11. The wireless communication circuitry 230 may also, or alternatively, be configured to communicate via various other wireless communication technologies, including, but not limited to, BT/BLE, UWB, and/or LP/ULP. Further, in some embodiments, the wireless communication circuitry 230 may also, or alternatively, be configured to communicate via various other wireless communication technologies, including, but not limited to, Long-Term Evolution (LTE), LTE Advanced (LTE-A), Global System for Mobile (GSM), Wideband Code Division Multiple Access (WCDMA), CDMA2000, etc., for example when the AP is co-located with a base station in case of a small cell, or in other instances when it may be desirable for the AP 112 to communicate via various different wireless communication technologies.

Further, in some embodiments, as further described below, AP 112 may be configured to perform (and/or assist in performance of) the methods described herein.

### FIG. 3B—Client Station Block Diagram

FIG. 3B illustrates an example simplified block diagram of a client station 106, which may be one possible exemplary implementation of the device 110 illustrated in FIG. 2B. According to embodiments, client station 106 may be a user equipment (UE) device, a mobile device or mobile station, and/or a wireless device or wireless station. As shown, the client station 106 may include a system on chip (SOC) 300, which may include portions for various purposes. The SOC 300 may be coupled to various other circuits of the client station 106. For example, the client station 106 may include various types of memory (e.g., including NAND flash 310), a connector interface (I/F) (or dock) 320 (e.g., for coupling to a computer system, dock, charging station, etc.), the display 360, cellular communication circuitry 330 such as for LTE, GSM, etc., short to medium range wireless communication circuitry 329 (e.g., Bluetooth™ and WLAN circuitry), low power/ultra-low power (LP/ULP) radio 339, and ultra-wideband radio 341. The client station 106 may further include one or more smart cards 310 that incorporate SIM (Subscriber Identity Module) functionality, such as one or more UICC(s) (Universal Integrated Circuit Card(s)) cards 345. The cellular communication circuitry 330 may couple to one or more antennas, such as antennas 335 and 336 as shown. The short to medium range wireless communication circuitry 329 may also couple to one or more antennas, such as antennas 337 and 338 as shown. LP/ULP radio 339 may couple to one or more antennas, such as antennas 347 and 348 as shown. Additionally, UWB radio 341 may couple to one or more antennas, such as antennas 345 and 346. Alternatively, the radios may share one or more antennas in addition to, or instead of, coupling to respective antennas or respective sets of antennas. Any or all of the radios may include multiple receive chains and/or multiple transmit chains for receiving and/or transmitting multiple spatial streams, such as in a multiple-input multiple output (MIMO) configuration.

As shown, the SOC 300 may include processor(s) 302, which may execute program instructions for the client station 106 and display circuitry 304, which may perform graphics processing and provide display signals to the display 360. The SOC 300 may also include motion sensing circuitry 370, which may detect motion of the client station 106, for example using a gyroscope, accelerometer, and/or any of various other motion sensing components. The processor(s) 302 may also be coupled to memory management unit (MMU) 340, which may be configured to receive addresses from the processor(s) 302 and translate those addresses into locations in memory (e.g., memory 306, read only memory (ROM) 350, NAND flash memory 310) and/or to other circuits or devices, such as the display circuitry 304, cellular communication circuitry 330, short range wireless communication circuitry 329, LP/ULP communication circuitry 339, UWB communication circuitry 341, connector interface (I/F) 320, and/or display 360. The MMU 340 may be configured to perform memory protection and page table translation or set up. In some embodiments, the MMU 340 may be included as a portion of the processor(s) 302.

As noted above, the client station 106 may be configured to communicate wirelessly directly with one or more neighboring client stations and/or one or more positional tag devices 108. The client station 106 may be configured to communicate according to a WLAN RAT for communication in a WLAN network, such as that shown in FIG. 2C. Further, in some embodiments, as further described below, client station 106 may be configured to perform (and/or assist in performance of) the methods described herein.

As described herein, the client station 106 may include hardware and/or software components for implementing the features described herein. For example, the processor 302 of the client station 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the UE 106, in conjunction with one or more of the other components 300, 304, 306, 310, 320, 329, 330, 335, 336, 337, 338, 339, 340, 341, 345, 346, 347, 348, 350, and/or 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 204.

Further, as described herein, cellular communication circuitry 330 and short-range wireless communication circuitry 329 may each include one or more processing elements. Thus, each of cellular communication circuitry 330 and short-range wireless communication circuitry 329 may include one or more integrated circuits (ICs) configured to perform the functions of cellular communication circuitry 330 and short-range wireless communication circuitry 329, respectively.

### FIG. 3C—Wireless Node Block Diagram

FIG. 3C illustrates one possible block diagram of a wireless node 107, which may be one possible exemplary implementation of the device 110 illustrated in FIG. 2B. As shown, the wireless node 107 may include a system on chip (SOC) 301, which may include portions for various purposes. For example, as shown, the SOC 301 may include processor(s) 303 which may execute program instructions for the wireless node 107, and display circuitry 305 which may perform graphics processing and provide display signals to the display 361. The SOC 301 may also include motion sensing circuitry 371 which may detect motion of the wireless node 107, for example using a gyroscope, accelerometer, and/or any of various other motion sensing components. The processor(s) 303 may also be coupled to memory management unit (MMU) 341, which may be configured to receive addresses from the processor(s) 303 and translate those addresses to locations in memory (e.g., memory 307, read only memory (ROM) 351, flash memory 311). The MMU 341 may be configured to perform memory protection and page table translation or set up. In some embodiments, the MMU 341 may be included as a portion of the processor(s) 303.

As shown, the SOC 301 may be coupled to various other circuits of the wireless node 107. For example, the wireless node 107 may include various types of memory (e.g., including NAND flash 311), a connector interface 321 (e.g., for coupling to a computer system, dock, charging station, etc.), the display 361, and wireless communication circuitry (radio) 381 (e.g., for LTE, LTE-A, CDMA2000, Bluetooth, Wi-Fi, NFC, GPS, UWB, LP/ULP, etc.).

The wireless node 107 may include at least one antenna, and in some embodiments, multiple antennas 387 and 388, for performing wireless communication with base stations and/or other devices. For example, the wireless node 107 may use antennas 387 and 388 to perform the wireless communication. As noted above, the wireless node 107 may in some embodiments be configured to communicate wirelessly using a plurality of wireless communication standards or radio access technologies (RATs).

The wireless communication circuitry (radio) 381 may include Wi-Fi Logic 382, a Cellular Modem 383, BT/BLE Logic 384, UWB logic 385, and LP/ULP logic 386. The Wi-Fi Logic 382 is for enabling the wireless node 107 to perform Wi-Fi communications, e.g., on an 802.11 network and/or via peer-to-peer communications (e.g., NAN). The BT/BLE Logic 384 is for enabling the wireless node 107 to perform Bluetooth communications. The cellular modem 383 may be capable of performing cellular communication according to one or more cellular communication technologies. The UWB logic 385 is for enabling the wireless node 107 to perform UWB communications. The LP/ULP logic 386 is for enabling the wireless node 107 to perform LP/ULP communications. Some or all components of the wireless communication circuitry 381 may be used for communications with a positional tag device 108.

As described herein, wireless node 107 may include hardware and software components for implementing embodiments of this disclosure. For example, one or more components of the wireless communication circuitry 381 of the wireless node 107 may be configured to implement part or all of the methods described herein, e.g., by a processor executing program instructions stored on a memory medium (e.g., a non-transitory computer-readable memory medium), a processor configured as an FPGA (Field Programmable Gate Array), and/or using dedicated hardware components, which may include an ASIC (Application Specific Integrated Circuit). For example, in some embodiments, as further described below, wireless node 107 may be configured to perform (and/or assist in the performance of) the methods described herein.

### Probe Before Talk

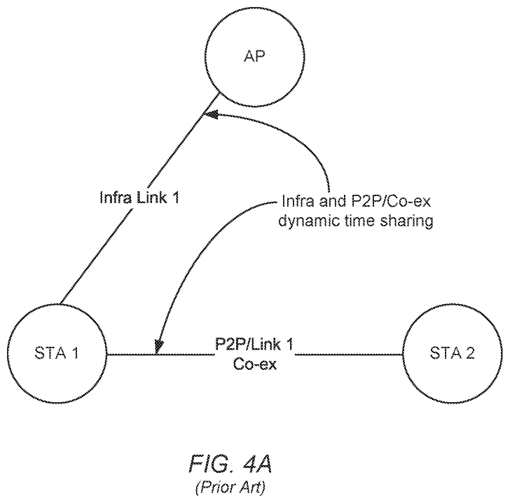

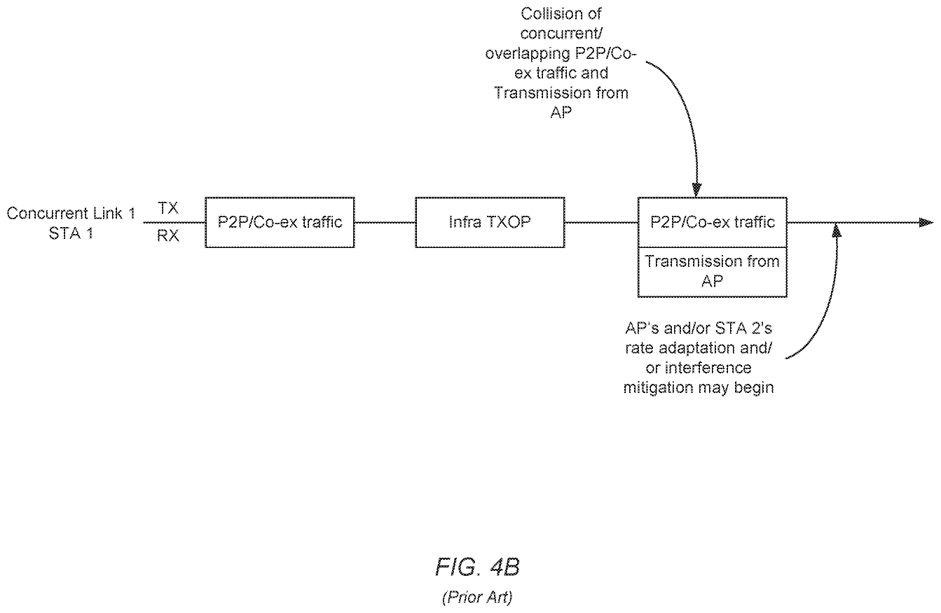

In current implementations, a wireless local area network (WLAN) device (e.g., a wireless station) often needs to manage multiple Wi-Fi interfaces. For example, as illustrated by FIG. 4A, a WLAN device (e.g., STA 1) may need to manage an infrastructure Wi-Fi connection with an access point (e.g., AP) and a Wi-Fi peer-to-peer (P2P) connection with another WLAN device (e.g., STA 2). Both of these connections may be on the same link (e.g., link 1). As another example, the WLAN device may need to manage co-existence between radio access technologies such Wi-Fi and Bluetooth. In addition, radio resources within the WLAN device are time shared by the infrastructure Wi-Fi connection, the P2P connection, and any co-existing radio access technologies, e.g., as illustrated by FIG. 4B. Given that the WLAN device dynamically time shares the radio resources between the various competing elements, communications may collide leading to a reduction in transmission rate which may not be suitable based on the reasons for failed transmissions and, as such, the transmission rate reduction may be undesirable.

Embodiments described herein relate to systems, methods, and mechanisms for a Probe-Before-Talk (PBT) to manage the operation of Wi-Fi multiple interfaces and/or Wi-Fi co-existence with other technologies. Further, embodiments described herein relate to systems, methods, and mechanisms for PBT setup, a PBT session, and PBT termination. The systems, methods, and mechanisms described herein may support either a wireless station or an access point as an initiator of a transmit opportunity.

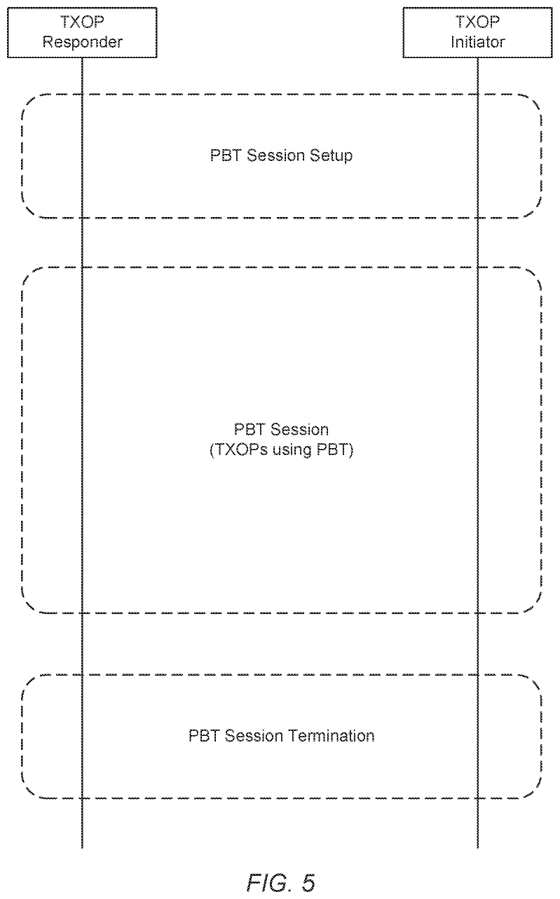

In some instances, a PBT mechanism may include three stages, e.g., a setup (PBT setup) stage, a session (e.g., PBT session) stage, and a termination (e.g., PBT termination) stage, e.g., as illustrated by FIG. 5. As shown, the setup stage may include a transmit opportunity (TXOP) responder (e.g., such as a wireless station 106) requesting a transmit opportunity initiator (e.g., such as another wireless station 106 and/or an access point 112) to set up a session, e.g., a PBT session. In some instances, the request to for session setup may be via a setup indication during an association procedure between the initiator and responding and/or via a request/response frame (e.g., a PBT request/response frame), such as a management frame, exchange after association. In both instances, additional parameters, such as usage threshold (e.g., PBT usage threshold, frame types that may invoke PBT) may be exchanged. After session setup, the PBT session may include one or more transmit opportunities using PBT. After the PBT session, a transmit opportunity responder may request that a transmit opportunity initiator terminate the PBT session. In some instances, termination of the PBT session may include the initiator and responder performing disassociation and/or the session termination may be via a termination indication via a request/response frame (e.g., a PBT termination request/response frame), such as a management frame, exchange prior to disassociation.

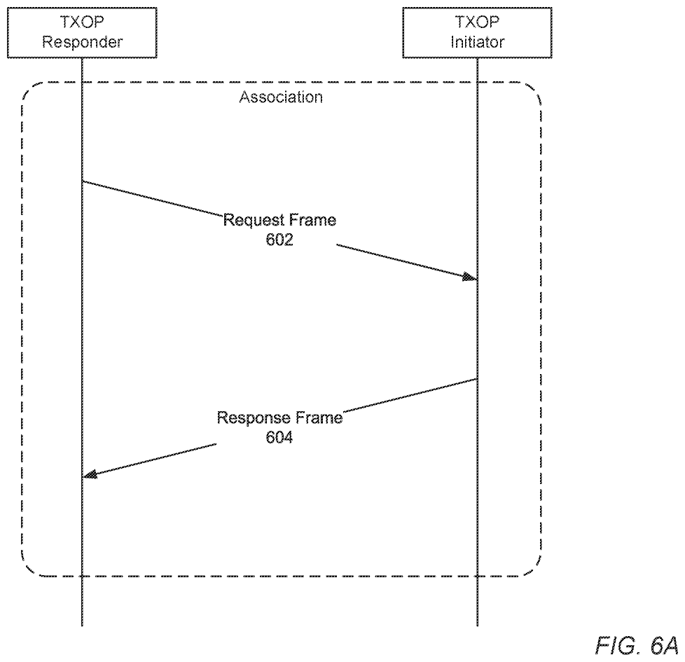

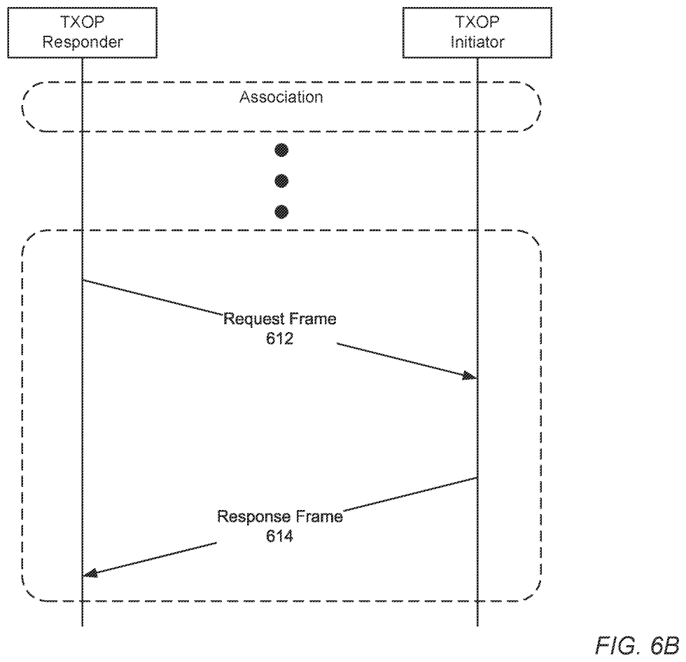

FIGS. 6A and 6B illustrate examples of signaling for PBT session setup, according to some embodiments. The signaling shown in FIGS. 6A and 6B may be used in conjunction with any of the systems, methods, or devices shown in the Figures, among other devices. In various embodiments, some of the signaling shown may be performed concurrently, in a different order than shown, or may be omitted. Additional signaling may also be performed as desired. As shown, this signaling may flow as follows.

Turning to FIG. 6A, as shown, PBT session setup may be included as part of an association (and/or re-association) process/procedure. Thus, during association/re-association, a transmit opportunity responder (e.g., TXOP Responder) may transmit a request frame 602 that may include a PBT request to a transmit opportunity initiator. The transmit opportunity initiator (e.g., TXOP Initiator) may transmit a response frame 604 that may include a PBT response.

Turning to FIG. 6B, as shown, after association and/or re-association, a request frame 612, such as a PBT request frame, may be transmitted by a transmit opportunity responder (e.g., TXOP Responder) to a transmit opportunity initiator (e.g., TXOP Initiator) to request use of PBT (e.g., to request PBT session setup). Then, a response frame 614, such as PBT response frame may be transmitted by the transmit opportunity initiator to the transmit opportunity responder to confirm the use of PBT. In some instances, a request/response frame may be a management frame. In some instances, instead of transmitting an independent request/response frame, the request/response may be piggybacked to (e.g., add to and/or included in) other frames.

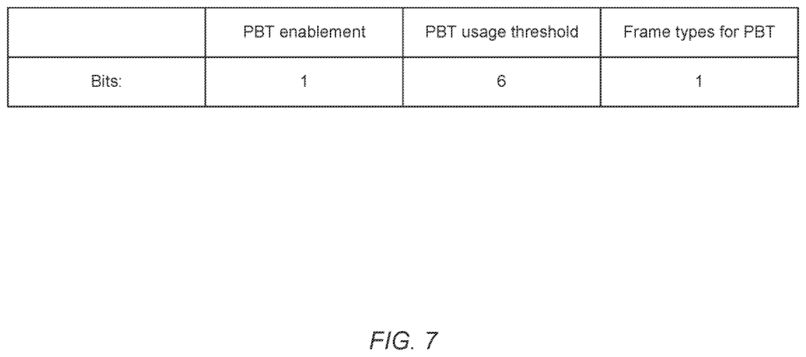

In some instances, an information element, frame fields, and/or frame subfields may include information associated with PBT setup, e.g., such as indications of enablement, PBT usage threshold, and/or frame types for PBT. In some instances, an indication of enable may be 1 bit, an indication of PBT usage threshold may include 6 bits, and frame types for PBT may include 1 bit, e.g., as illustrated by FIG. 7. In some instances, when PBT information is included in a request, the indication of enablement may be set to 1 to request to enable PBT and 0 otherwise, the indication of PBT usage threshold may indicate a requested minimal transmit opportunity duration that may invoke PBT (e.g., PBT is not used for transmit opportunities less/shorter than the threshold), and the indication of frame types for PBT may be set to 1 to request PBT to be used for transmission of only data frames and set to 0 to request PBT to be used for transmission of all frame types (e.g., including data frames). In some instances, when PBT information is included in a response, the indication of enablement may be set to 1 to confirm enablement of PBT and 0 otherwise, the indication of PBT usage threshold may indicate a confirmed minimal transmit opportunity duration that may invoke PBT (e.g., PBT is not used for transmit opportunities less/shorter than the threshold), and the indication of frame types for PBT may be set to 1 to confirm PBT to be used for transmission of only data frames and set to 0 to confirm PBT to be used for transmission of all frame types (e.g., including data frames, management frames, and/or control frames). Note that the duration may be specified in terms of 500 microseconds.

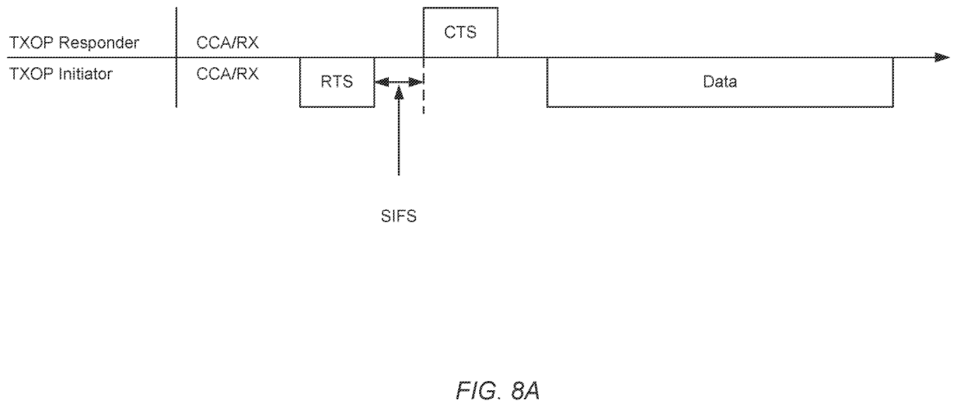

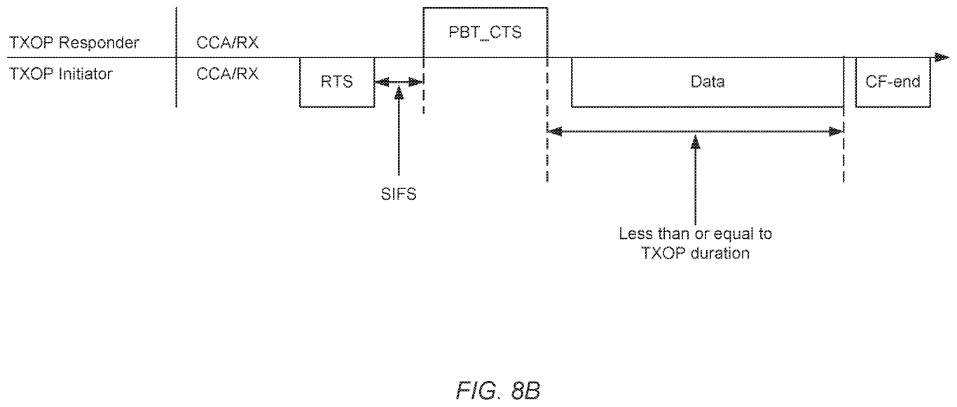

FIGS. 8A and 8B illustrate examples of transmit opportunities using PBT, according to some embodiments. As shown in FIG. 8A, after PBT setup, a transmit opportunity initiator (e.g., TXOP Initiator) may always transmit a request-to-send (RTS) frame first in a transmit opportunity. Then, if available, a transmit opportunity responder (e.g., TXOP Responder) may transmit a clear-to-send (CTS) frame as a response, e.g., after a short interframe space (SIFS). Further, the transmit opportunity initiator may then start data transmission upon successful reception of the CTS, e.g., based on the PBT agreement and/or configuration confirmed during setup. Note that in some instances, an access point may request a wireless station to send an RTS frame before data transmission when a transmit opportunity duration meets a threshold value. Note further that the PBT mechanism may allow a wireless station to request that an access point send an RTS frame before data transmission.

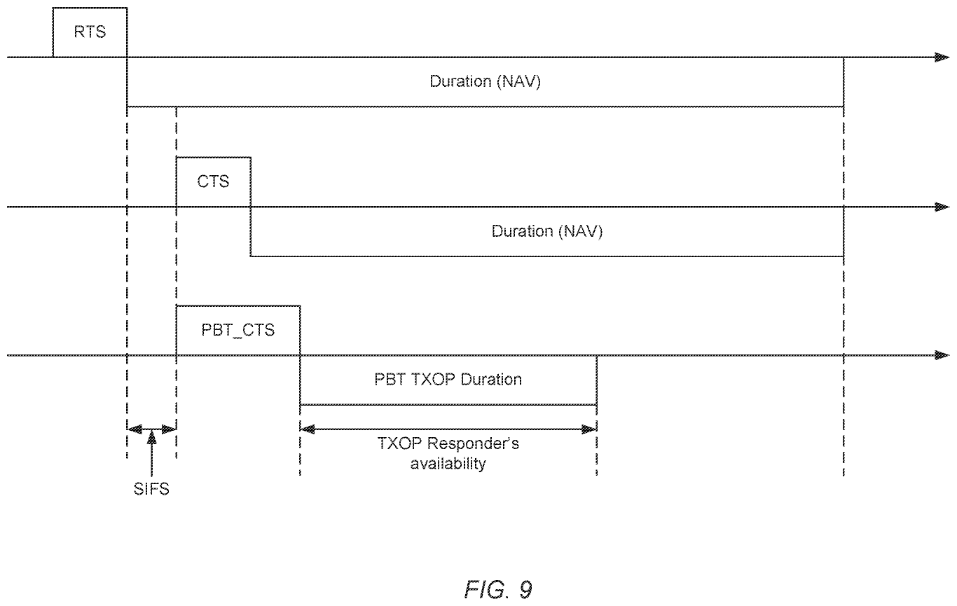

Turning to FIG. 8B, as shown, after PBT setup, a transmit opportunity initiator (e.g., TXOP Initiator) may always transmit a request-to-send (RTS) frame first in a transmit opportunity. Then, if available, a transmit opportunity responder (e.g., TXOP Responder) may transmit a modified clear-to-send (CTS) frame, e.g., such as a PBT CTS frame, as a response, e.g., after a short interframe space (SIFS). The modified CTS frame may include availability information, such as an availability duration of the transmit opportunity responder for the transmit opportunity. Note that a range for the duration may be from 0 to 65.53 milliseconds with a value of 0 indicating unavailability. Note further that a duration of data transmission following a modified CTS frame may be less than or equal to PBT transmit opportunity duration included in the modified CTS frame, e.g., as illustrated by FIG. 9. In some instances, the modified CTS frame may include additional unavailability information. In addition, after the modified CTS frame, any downlink physical layer protocol data unit (PPDU) during a PBT transmit opportunity duration may be interpreted as an acknowledgement to the modified CTS. Additionally, after the modified CTS frame, if no downlink PPDU is received during PBT transmit opportunity duration, the transmit opportunity responder may maintain legacy behavior. Further, the transmit opportunity initiator may transmit a CF-end frame to end the PBT transmit opportunity and cancel remaining NAV of neighboring stations. The RTS frame may be a single user (SU) RTS (SU-RTS) frame, a multi-user (MU) RTS (MU-RTS) frame, and/or a modified RTS that serves the same/similar function as a SU-RTS frame and/or an MU RTS frame.

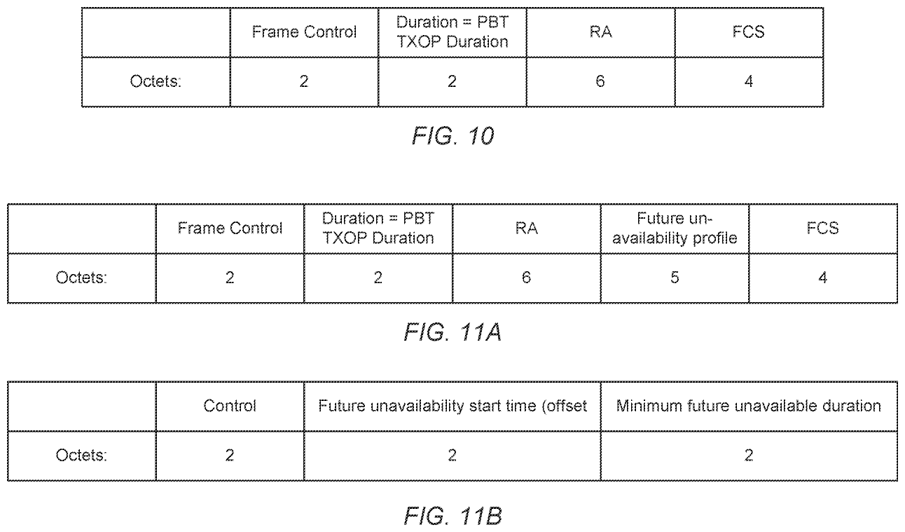

FIGS. 10 and 11A illustrate examples of modified CTS frame formats, according to some embodiments. FIG. 11B illustrates an example of a future unavailability profile field of a modified CTS frame, according to some embodiments. As shown in FIG. 10, a CTS frame may be repurposed as a modified CTS frame. In such instances, the frame type may be the same as a CTS's frame type, a duration field of the CTS frame may be interpreted as a PBT transmit opportunity duration, and a transmit opportunity initiator may recognize the modified CTS frame based on having a PBT agreement (e.g., having performed PBT setup) with the transmitter of the modified CTS frame. Note that a NAV of both a legacy wireless station and a PBT capable wireless station (e.g., such as wireless station 106) may beset by a duration field of an RTS frame proceeding a CTS or modified CTS frame.

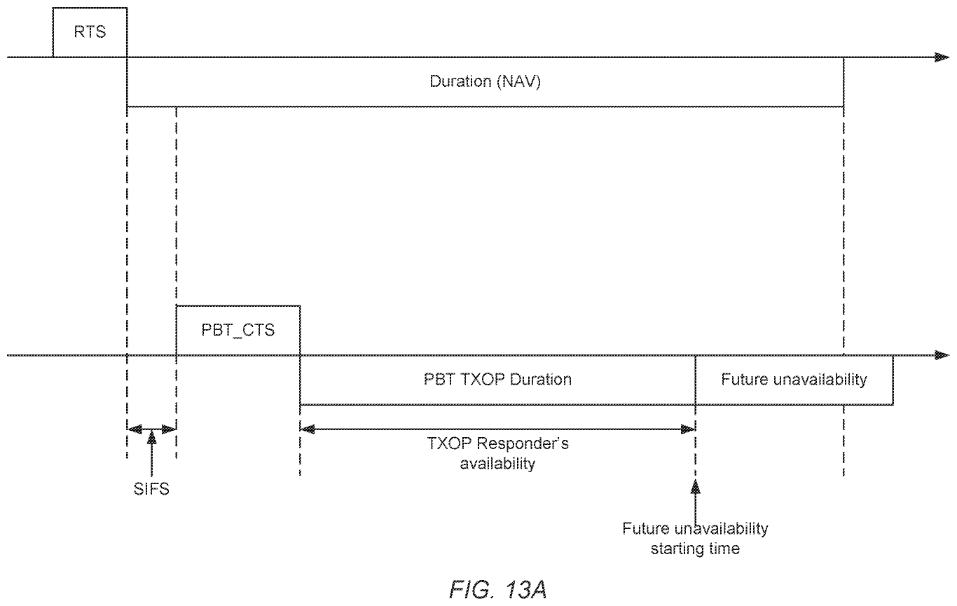

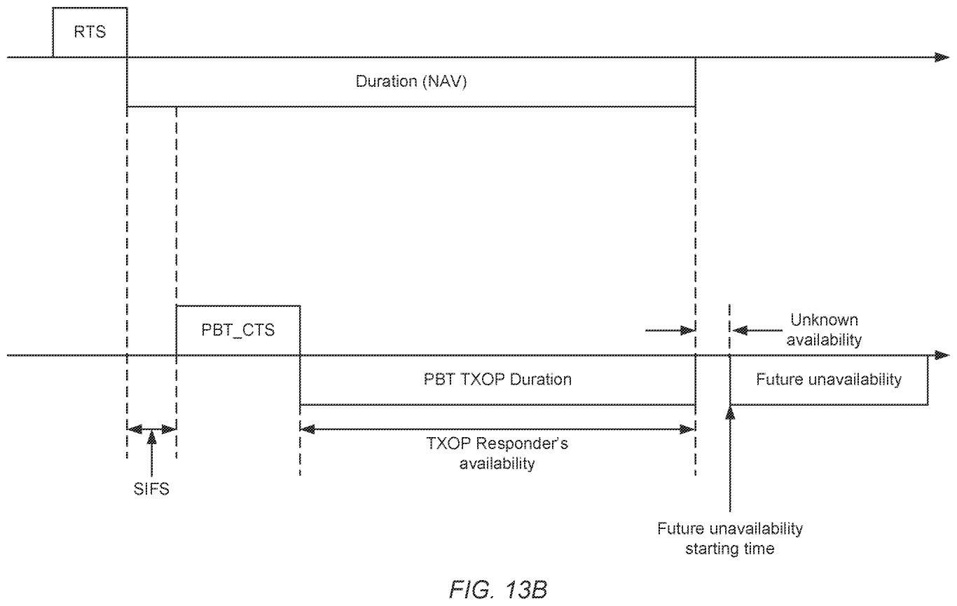

Turning to FIG. 11A, as shown, in some instances, a modified CTS frame may include a frame control field, a duration field, an RA field, a future unavailability profile field, and an FCS field. The future unavailability profiled field may be used to convey additional unavailable information as shown in FIG. 11B and further illustrated by FIGS. 13A and 13B. As shown in FIG. 11B, the future unavailability profile field may include a control field, a future unavailability start time (offset) field, and/or a minimum future unavailability duration field. The control field may indicate whether future unavailability profile is included and/or whether the transmitter of modified CTS will be in a power save mode/state at the end of PBT transmit opportunity duration and onward.

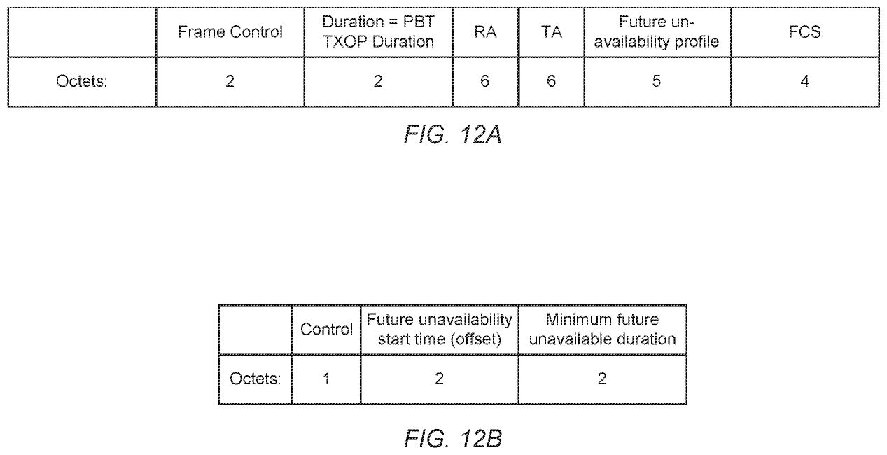

Turning to FIG. 12A, as shown, in some instances, a modified CTS frame may include a frame control field, a duration field, an RA field, a TA field, a future unavailability profile field, and an FCS field. The future unavailability profiled field may be used to convey additional unavailable information as shown in FIG. 12B. In addition, the RA field may be set to a TA field of a soliciting device and the TA field may be set to a MAC address of a transmitter of a modified CTS frame. As shown in FIG. 12B, the future unavailability profile field may include a control field, a future unavailability start time (offset) field, and/or a minimum future unavailability duration field. The control field may indicate whether future unavailability profile is included and/or whether the transmitter of modified CTS will be in a power save mode/state at the end of PBT transmit opportunity duration and onward.

FIG. 13A illustrates timing of signaling when a PBT transmit opportunity duration is less than an RTS duration. As shown, future unavailability may be designated as an offset from a start of a PBT TXOP duration (e.g., a start of TXOP responder's availability). FIG. 13B illustrates timing of signaling when a PBT transmit opportunity duration is equal to an RTS duration, according to some embodiments. As shown, future unavailability may be designated as an offset from a start of a PBT TXOP duration (e.g., a start of TXOP responder's availability). In addition, availability between an end of the PBT TXOP duration and a start of the future unavailability may not be known. Additionally, Table 1 illustrates an expected behavior of a transmit opportunity initiator with respect to a transmit opportunity responder's various availability states, according to some embodiments.

TABLE 1
TXOP Initiator Behavior

| TXOP Responder's | |
|---|---|
| Availability | |
| Indication in PBT_CTS | Expected TXOP Initiator's Behavior |
| Available | Downlink transmission |
| Unavailable | No downlink transmission (e.g., no initial |
| | transmission or re-trial) of a frame |
| Unknown | TXOP initiator makes is own decision |
| | (e.g., legacy behavior) |

In some instances, a transmit opportunity responder (e.g., a transmitter of a modified CTS frame) may enter a power save mode at an end of a PBT transmit opportunity. In such instances, using the modified CTS frame, the transmitter of the modified CTS frame may indicate whether it will be in a power save mode at the end of the PBT transmit opportunity duration onward. In some instances, a special value of the control subfield of the future availability profile field of the modified CTS frame may indicate the power save mode. In some instances, a power management bit in a frame control field of the modified CTS frame may be set to a value of 1 to indicate the power save mode. In some instances, an all “1s” value of a minimum future unavailable duration subfield of the future profile field of the modified CTS frame may indicate the power save mode. Note that if the transmitter of modified CTS frame indicates it will be in a power save mode at the end of PBT transmit opportunity duration, the transmit opportunity initiator may not transmit to the transmitter of the modified CTS frame until receiving a power save trigger frame (e.g., PS-poll frame) from the transmitter of the modified CTS frame. In addition, the transmitter of the modified CTS frame may use legacy methods (e.g., such as setting a power management subfield of a frame control field of a frame to 0) to exit the power save mode.

In some instances, during an ongoing transmit opportunity, a transmit opportunity responder may become aware of an upcoming peer-to-peer or co-existence event. As a result, in some instances, the transmit opportunity responder may include a request to the transmit opportunity initiator that the transmit opportunity initiator send an additional RTS before the next DL PPDU in a block acknowledgment. In other instances, as a result, the transmit opportunity responder may include a future unavailable profile in a block acknowledgment.

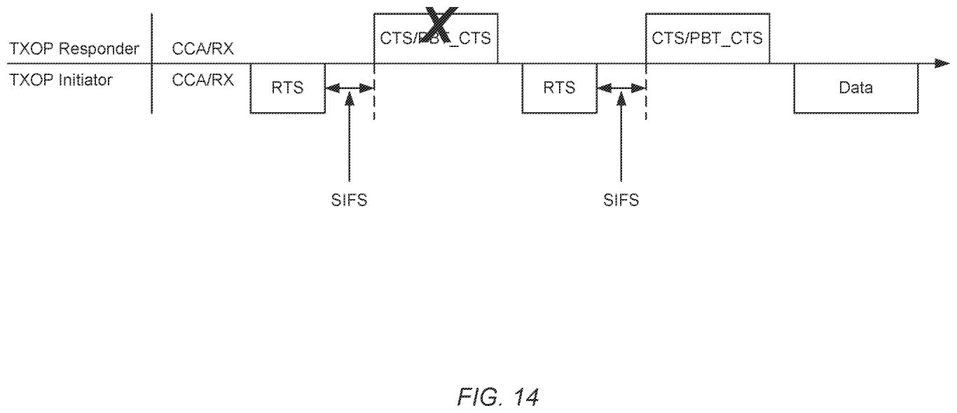

As discussed above, a transmit opportunity initiator may always transmit an RTS frame first in a transmit opportunity. Further, when the transmit opportunity initiator does not receive a CTS (or modified CTS) frame successfully (e.g., the transmit opportunity responder is not available) as shown in FIG. 14, the transmit opportunity initiator may not reduce the transmission rate, may not transmit data packets, and may transmit another RTS frame at a later time.

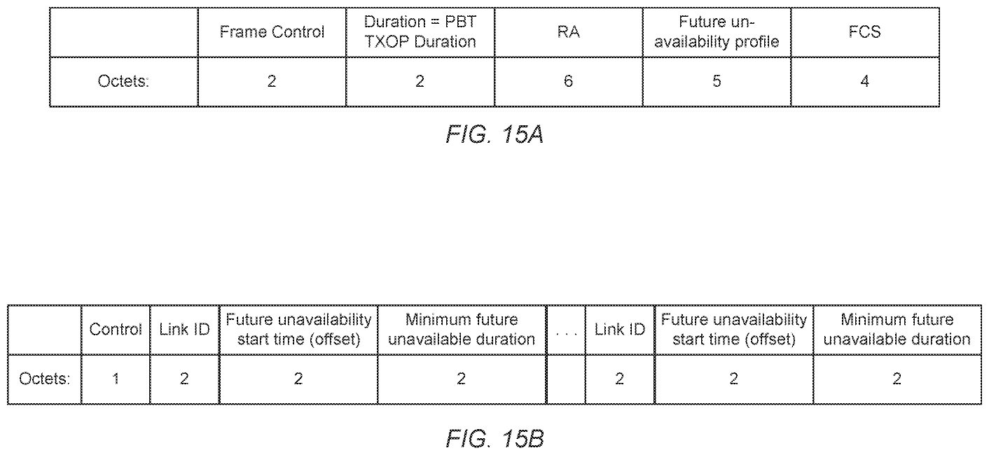

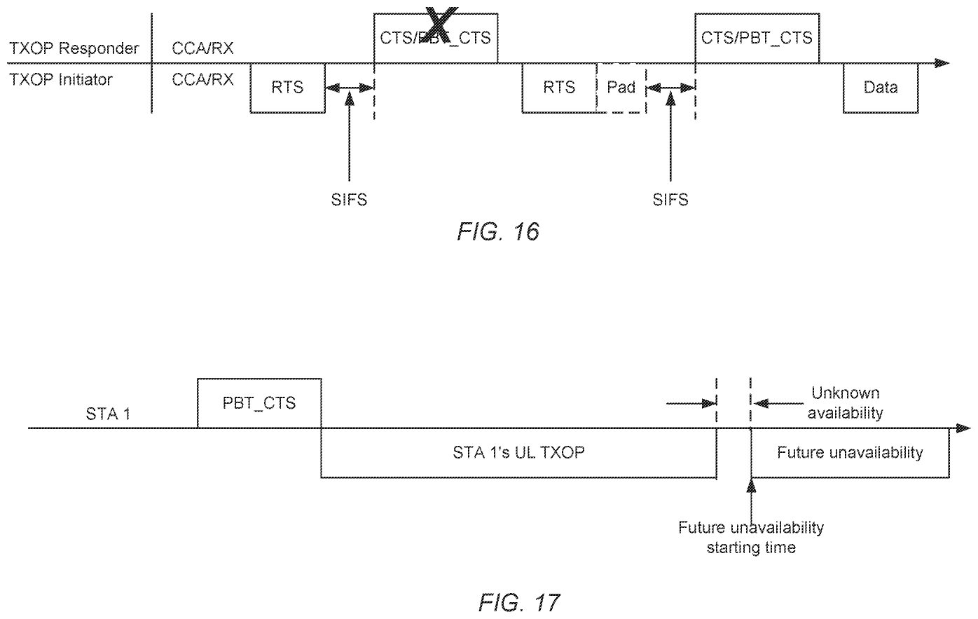

In some instances, a future unavailability profile field of a modified CTS frame may be expanded to include unavailability information for multiple links, each corresponding to one link identifier as illustrated by FIGS. 15A and 15B. Additionally and/or alternatively, if the same future unavailability information (e.g., future unavailability start time and/or minimum future unavailable duration) applies to multiple links, the future unavailability profiled field may include a corresponding bitmap whose setting indicates which links the future unavailability information applies. In other words, when a bit position k in the bitmap is set to a value of one, the bit may indicate that the future unavailability information applies to the link identified by the bit position k. In addition, when PBT is used in multiple link scenarios, a padding duration may be added after the PBT_ICF. (e.g., RTS) to accommodate a link switch time, e.g., as shown in Figure 16. Note that the padding duration may be negotiated during PBT session set up, for example among {0, 16, 32, 64, 128, 256} microseconds. In some instances, if an infrastructure link and a peer-to-peer or co-existence are the same, a padding duration (e.g., PBT_PAD) may be 0. In some instances, if an infrastructure link and a peer-to-peer or co-existence link are different, a padding duration (e.g., PBT_PAD) may be greater than 0.

In some instances, a modified CTS frame may be transmitted as an unsolicited frame, e.g., as illustrated by FIG. 17. For example, a modified CTS frame may be transmitted without a soliciting RTS frame. In other words, the modified CTS may be transmitted as a first frame in a frame exchange. In such an instance, a frame field of the modified CTS frame may carry different interoperation as compared to a solicited modified CTS frame. For example, a duration field of the modified CTS may be set to cover a duration of a station's uplink transmission and/or a duration of a station's uplink transmission plus future unavailability. An RA field may be set a MAC address of an intended receiver of the unsolicited modified CTS frame. the MAC address may an individual address or a group address (e.g., multicast or broadcast). A TA field may be set to a MAC address of the transmitter of the unsolicited modified CTS frame.

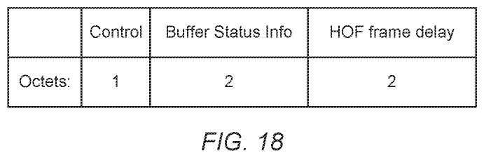

In some instances, an enhanced buffer status report poll (eBSRP) or a PBT frame may enable multi-user usage scenarios. For example, in some instances, in addition to using an RTS frame as an initial control frame (ICF) and a CTS and/or modified CTS as a response frame for probe before talk, a multi-user RTS (MU-RTS) frame, an enhanced MU-RTS frame, a BSRP frame (e.g., such as an eBSRP as illustrated by FIG. 18), and/or an enhanced ICF may be used for probe before talk procedures. The enhanced MU-RTS frame (e.g., a PBT_MU-RTS frame and/or an eMU-RTS frame) may solicit responses from one or more transmission opportunity responders. In addition, when a BSRP frame is transmitted as part of a probe before talk procedure (or session) as an ICF, a modified CTS frame (e.g., instead of a QoS null frame) may be transmitted as a response frame to the ICF. Further, an enhanced ICF may solicit responses from one or more transmission opportunity responders. Note probe before talk procedure multiuser ICFs and response frames, e.g., as described above, may allow multiple transmit opportunity responders to send differing content (e.g., such as PBT TXOP duration and/or future availability information). Note further that when a probe before talk ICF is sent to multiple TXOP responders, the resulting remaining transmit opportunity duration may be less than or equal to a minimum of a PBT TXOP duration included in response frames from all TXOP responders. Note that in some instances, if and/or when multiple responders (e.g., wireless stations) indicate different PBT_TXOP durations in modified CTS frames, an initiator (e.g., access point, such as AP 112) may take a minimum of the PBT_TXOP durations as a duration for subsequent MU transmission.

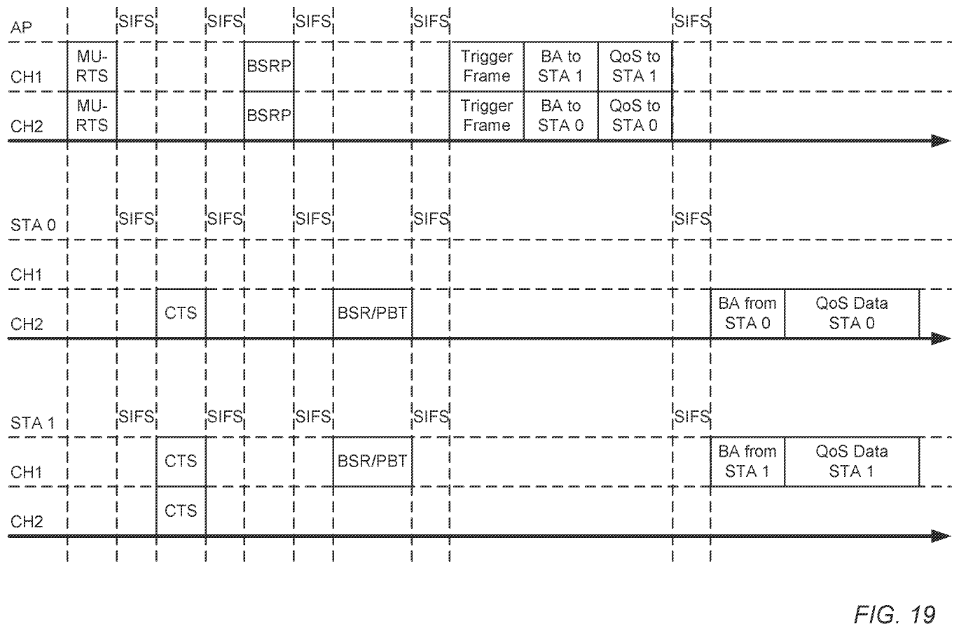

In some instances, probe before talk for a multi-user scenario may initiate with a BSRP frame broadcast/multicast to multiple users (e.g., multiple stations). Each station may respond with a buffer status report (BSR) frame and/or a modified CTS frame (e.g., a PBT frame) being transmitted, e.g., in a high efficiency (HE) and/or extremely high throughput (EHT) trigger based (TB) Physical Layer Protocol Data Unit (PPDU) such that content of the BSR/PBT frame may be different from different stations. Note that, in at least some instances (e.g., optionally), a multi-user RTS/CTS procedure may be performed prior to transmission of the BSRP frame, e.g., to protect against hidden nodes from overlapping basic service sets (OBSSs). For example, FIG. 19 illustrates one example of such a sequence, according to some embodiments. As shown, an initiating device, e.g., such as an access point (AP) (e.g., AP 112) may transmit/broadcast a multi-user RTS (MU-RTS) frame on multiple channels (e.g., CH1 and CH2). As shown, a first station, e.g., STA 0, which may be a wireless station 106, may respond, e.g., after receiving the MU-RTS on a second channel (e.g., CH2), with a CTS frame on the second channel while a second station, e.g., STA 1, which may also be a wireless station 106, may respond, e.g., after receiving the MU-RTS on a first channel (e.g., CH1) and the second channel, with a CTS frame on both a first channel (e.g., CH1) and the second channel. In response, the initiating device, e.g., after receiving the CTS frames from the first station and the second station, may transmit/broadcast a BSRP frame on both the first channel and the second channel. The first station, upon receiving the BSRP frame on the second channel, may respond on the second channel with a BSR and/or modified CTS (e.g., PBT) frame and the second station may, after receiving the BSRP frame on the first channel, respond on the first channel also with a BSR and/or modified CTS (e.g., PBT) frame. The initiating device, after receiving the BSR/PBT frames, may then transmit a trigger frame, block acknowledgment (BA), and Quality of Service (QOS) data frame to the first station on the second channel and to the second station on the first channel. The first station, upon receiving the trigger frame, BA, and QoS data, may respond by sending a BA and QoS data frame to the initiating device on the second channel. Similarly, the second station, upon receiving the trigger frame, BA, and QoS data may respond by sending a BA and QoS data frame to the initiating device on the first channel. The initiating device may receive the BAs and QoS data on the respective channels from the first station and the second station. In some instances, the QoS data sent by the initiating device and the corresponding BA may not be present if and/or when the initiating device is an access point, such as AP 112) that sends only down link data.

In some instances, a BSRP/BSR sequence may be performed prior to a downlink multi-user transmission. In such instances, a QoS data frame and/or a QoS null frame may be solicited for a station to report its requested transmit opportunity duration. Alternatively, a probe before talk (e.g., a modified CTS) frame may be solicited instead of a QoS data/null frame to convey additional (e.g., more advanced) co-existence related information. In some instances, a QoS data frame and/or a QoS null frame may be used as an un-solicited way for station reporting.

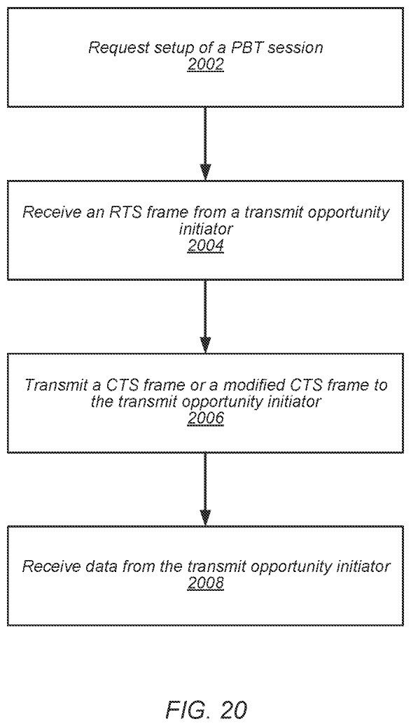

FIG. 20 illustrates a block diagram of an example of a method for a PBT procedure, according to some embodiments. The method shown in FIG. 20 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 2002, a device, e.g., such as a wireless station 106, a wireless node 107, and/or an access point 112, may request setup of a PBT session. In some instances, the PBT setup may be included as part of association or re-association with the transmit opportunity initiator. In some instances, the PBT setup may occur after association or re-association with the transmit opportunity initiator. In some instances, to request setup of the PBT session, the device may send information associated with PBT setup to the transmit opportunity initiator. The information associated with PBT setup may be included in an information element, frame fields, and/or frame subfields. In some instances, the information associated with PBT setup may include one or more of an indication of enablement, an indication of PBT usage threshold, and/or an indication of frame types for PBT.

At 2004, the device may receive a request-to-send (RTS) frame from a transmit opportunity initiator, e.g., such as from a wireless station 106, a wireless node 107, and/or an access point 112.

At 2006, the device may transmit one of a clear-to-send (CTS) frame or a modified CTS frame to the transmit opportunity initiator. In some instances, a duration field of a CTS frame may be interpreted as a PBT transmit opportunity duration. The modified CTS frame may include one or more of a frame control field, a duration field, an RA field, a future unavailability profile field, and/or an FCS field. The future unavailability profile field may include one or more of a control field, a future unavailability start time (offset) field, and/or a minimum future unavailability duration field. The control field may indicate whether a future unavailable profile is included and/or whether the transmitter of a modified CTS frame will be in a power save mode/state at the end of PBT transmit opportunity duration and onward. The modified CTS frame may be expanded to support multiple links. The future unavailability profile field may be expanded to support multiple links.

At 2008, the device may receive data from the transmit opportunity initiator. The data may be received during a transmission duration that is less than or equal to a PBT transmit opportunity duration indicated in one of the CTS frame or modified CTS frame transmitted by the device. In some instances, the device may not receive data from the transmit opportunity initiator during an unavailable time indicated in a future unavailability profile transmitted by the device to the transmit opportunity initiator. In some instances, the PBT transmit opportunity duration may be less than an RTS duration. In some instances, the PBT transmit opportunity duration may be equal to an RTS duration.

In some instances, the RTS frame may be a multi-user (MU) RTS (MU-RTS). In such instances, the device may receive a buffer status report probe (BSRP) frame and transmit one of a BSR frame or a modified CTS frame. The device may receive one or more of a trigger frame, a block acknowledgment frame, or a quality of service (QOS) information frame and transmit one or more of a block acknowledgement frame or a QoS data frame in response to receiving data. The data may be received during a transmission duration that is less than or equal to a PBT transmit opportunity duration indicated in one of the BSR frame or modified CTS frame transmitted by the device. In some instances, the device may not receive data from the transmit opportunity initiator during an unavailable time indicated in a future unavailability profile transmitted by the device.

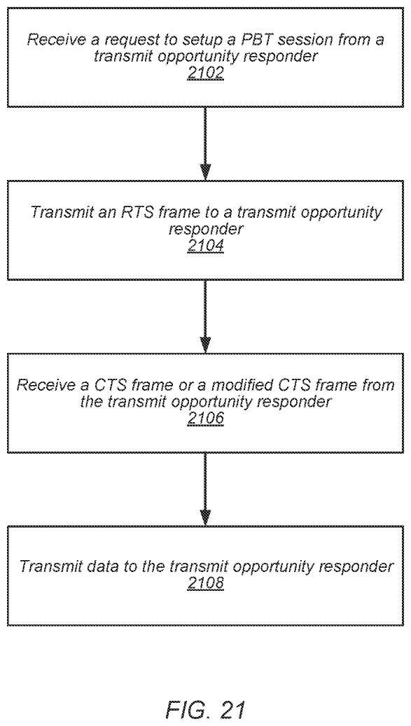

FIG. 21 illustrates a block diagram of an example of another method for a PBT procedure, according to some embodiments. The method shown in FIG. 21 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 2102, a device, e.g., such as a wireless station 106, a wireless node 107, and/or an access point 112, may receive a request to setup a PBT session, e.g., from a transmit opportunity responder, e.g., such as a wireless station 106, a wireless node 107, and/or an access point 112. In some instances, the PBT setup may be included as part of association or re-association with the transmit opportunity responder. In some instances, the PBT setup may occur after association or re-association with the transmit opportunity responder. In some instances, as part of the request to setup the PBT session, the device may receive information associated with PBT setup from the transmit opportunity responder. The information associated with PBT setup may be included in an information element, frame fields, and/or frame subfields. In some instances, the information associated with PBT setup may include one or more of an indication of enablement, an indication of PBT usage threshold, and/or an indication of frame types for PBT.

At 2104, the device may transmit a request-to-send (RTS) frame to the transmit opportunity responder.

At 2106, the device may receive one of a clear-to-send (CTS) frame or a modified CTS frame from the transmit opportunity responder. In some instances, a duration field of a CTS frame may be interpreted as a PBT transmit opportunity duration. The modified CTS frame may include one or more of a frame control field, a duration field, an RA field, a future unavailability profile field, and/or an FCS field. The future unavailability profile field may include one or more of a control field, a future unavailability start time (offset) field, and/or a minimum future unavailability duration field. The control field may indicate whether a future unavailable profile is included and/or whether the transmitter of a modified CTS frame will be in a power save mode/state at the end of PBT transmit opportunity duration and onward. The modified CTS frame may be expanded to support multiple links. The future unavailability profile field may be expanded to support multiple links.

At 2108, the device may transmit data to the transmit opportunity responder. The data may be transmitted during a transmission duration that is less than or equal to a PBT transmit opportunity duration indicated in one of the CTS frame or modified CTS frame received from the transmit opportunity responder. In some instances, the device may not transmit data to the transmit opportunity responder during an unavailable time indicated in a future unavailability profile received from the transmit opportunity responder. In some instances, the PBT transmit opportunity duration may be less than an RTS duration. In some instances, the PBT transmit opportunity duration may be equal to an RTS duration.

In some instances, when neither of the CTS frame or the modified CTS frame is received from the transmit opportunity responder, the device may transmit another RTS frame to the transmit opportunity responder and not change a data rate in response to not receiving the CTS frame or the modified CTS frame.

In some instances, the RTS frame may be a multi-user (MU) RTS (MU-RTS). In such instances, the device may transmit a buffer status report probe (BSRP) frame and receive one of a BSR frame or a modified CTS frame. The device may transmit one or more of a trigger frame, a block acknowledgment frame, or a quality of service (QOS) information frame and receive one or more of a block acknowledgement frame or a QoS data frame in response to transmitting data. The data may be transmitted during a transmission duration that is less than or equal to a PBT transmit opportunity duration indicated in one of the BSR frame or modified CTS frame transmitted by the device. In some instances, the device may not transmit data to the transmit opportunity responder during an unavailable time indicated in a future unavailability profile transmitted by the transmit opportunity responder.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a wireless device may be configured to include a processor (or a set of processors) and a memory medium, where the memory medium stores program instructions, where the processor is configured to read and execute the program instructions from the memory medium, where the program instructions are executable to cause the wireless device to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for a probe before talk (PBT) procedure, comprising:
requesting setup of a PBT session;
receiving a request-to-send (RTS) frame from a transmit opportunity initiator;
transmitting one of a clear-to-send (CTS) frame or a modified CTS frame to the transmit opportunity initiator; and
receiving data from the transmit opportunity initiator.

2. The method of claim 1,
wherein PBT setup is included as part of association or re-association with the transmit opportunity initiator.

3. The method of claim 1,
wherein PBT setup occurs after association or re-association with the transmit opportunity initiator.

4. The method claim 1,
wherein requesting setup of the PBT session includes sending information associated with PBT setup to the transmit opportunity initiator, and wherein the information associated with PBT setup is included in an information element, frame fields, and/or frame subfields.

5. The method of claim 4,
wherein the information associated with PBT setup includes one or more of an indication of enablement, an indication of PBT usage threshold, and/or an indication of frame types for PBT.

6. The method of claim 1,
wherein a duration field of a CTS frame is interpreted as a PBT transmit opportunity duration.

7. The method of claim 1,
wherein the modified CTS frame includes at least a future unavailability profile field, and wherein the future unavailability profile field includes at least a control field that indicates at least one of:
whether a future unavailable profile is included: or
whether the transmitter of a modified CTS frame will be in a power save mode at the end of PBT transmit opportunity duration and onward.

8. A wireless device, comprising:
at least one antenna;
at least one radio coupled to the at least one antenna, wherein the at least one radio comprises circuitry supporting at least two radio access technologies (RATs); and
a processing element coupled to the at least one radio; and
wherein the processing element is configured to cause the wireless device to:
request setup of a probe before talk (PBT) session;
receive a request-to-send (RTS) frame from a transmit opportunity initiator;
transmit one of a clear-to-send (CTS) frame or a modified CTS frame to the transmit opportunity initiator; and
receive data from the transmit opportunity initiator.

9. The wireless device of claim 8,
wherein the modified CTS frame is expanded to support multiple links, and wherein a future unavailability profile field included in the modified CTS frame is expanded to support multiple links.

10. The wireless device of claim 8,
wherein a PBT transmit opportunity duration is less than or equal to an RTS duration.

11. The wireless device of claim 9,
wherein the RTS frame comprises a multi-user (MU) RTS (MU-RTS), and wherein the processing element is further configured to cause the wireless device to:
receive a buffer status report probe (BSRP) frame;
transmit one of a BSR frame or a modified CTS frame;
receive one or more of a trigger frame, a block acknowledgment frame, or a quality of service (QOS) information frame; and
transmit one or more of a block acknowledgement frame or a QoS data frame.

12. The wireless device of claim 8,
wherein the modified CTS frame includes one or more of a frame control field, a duration field, a receiver address (RA) field, a future unavailability profile field, or a frame check sum (FCS) field.

13. The wireless device of claim 8,
wherein, to request of the PBT session, the processing element is further configured to cause the wireless device to send information associated with PBT setup to the transmit opportunity initiator.

14. The wireless device of claim 13,
wherein the information associated with PBT setup includes one or more of an indication of enablement, an indication of PBT usage threshold, and/or an indication of frame types for PBT.

15. An apparatus, comprising:
a memory; and
at least one processor in communication with the memory and configured to:
receive a request to setup a probe before talk (PBT)session;
generate instructions to transmit a request-to-send (RTS) frame to a transmit opportunity responder;
receive one of a clear-to-send (CTS) frame or a modified CTS frame from the transmit opportunity responder; and
generate instructions to transmit data to the transmit opportunity responder.

16. The apparatus of claim 15,
wherein the instructions to transmit data to the transmit opportunity responder are for a transmission duration that is less than or equal to a PBT transmit opportunity duration indicated in one of the CTS frame or modified CTS frame received from the transmit opportunity responder.

17. The apparatus of claim 15,
wherein the at least one processor is further configured to:
not transmit to the transmit opportunity responder during an unavailable time indicated in a future unavailability profile received from the transmit opportunity responder.

18. The apparatus of claim 15,
wherein, when neither of the CTS frame or the modified CTS frame is received from the transmit opportunity responder, the at least one processor is further configured to:
generate instructions to transmit another RTS frame to the transmit opportunity responder; and
not changing a data rate in response to not receiving the CTS frame or the modified CTS frame.

19. The apparatus of claim 15,
wherein the RTS frame comprises a multi-user (MU) RTS (MU-RTS), and wherein the at least one processor is further configured to:
generate instructions to transmit a buffer status report probe (BSRP) frame;
receive one of a buffer status report (BSR) frame or a modified CTS frame;
generate instructions to transmit one or more of a trigger frame, a block acknowledgment frame, or a quality of service (QOS) information frame;
generate instructions to transmit data to one or more transmit opportunity responders for a duration that is less than or equal to a PBT transmit opportunity duration indicated in one of the CTS frame or modified CTS frame by the one or more transmit opportunity responders; and
receive one or more of a block acknowledgement frame or a QoS data frame from the one or more transmit opportunity responders.

20. The apparatus of claim 19,
wherein the at least one processor is further configured to:
not transmit to a first transmit opportunity responder of the one or more transmit opportunity responders during a respective unavailable time indicated in a future unavailability profiles received from the first transmit opportunity responder.
